(19) United States
(12) Patent Application Publication
(10) Pub. No.: US 2015/0028760 A1
(43) Pub. Date: Jan. 29, 2015

(54) LED LUMINAIRE

(71) Applicant: SEOUL SEMICONDUCTOR CO., LTD., Ansan-si (KR)

(72) Inventors: Kang Nyung LEE, Ansan-si (KR); Sang Wook Han, Ansan-si (KR); Hyun Gu Kang, Ansan-si (KR)

(21) Appl. No.: 14/339,084

(22) Filed: Jul. 23, 2014

(30) Foreign Application Priority Data
Jul. 25, 2013 (KR) 10-2013-0088169

(51) Int. Cl. H05B 33/08

(52) U.S. Cl. CPC H05B 33/0806
USPC 315/201

(57) ABSTRACT

A light-emitting diode (LED) luminaire includes a light-emitting part, a rectification unit configured to perform full-wave rectification of an alternating current (AC) voltage to supply a first drive voltage to the light-emitting part, a power factor compensation unit configured to be charged with the first drive voltage during a charge period and supply a second drive voltage to the light-emitting part during a compensation period, and an LED drive controller configured to determine a voltage level of the first drive voltage or the second drive voltage and control sequential driving of the first LED group to the n^{th} LED group according to the determined voltage level, such that at least 60% of the LEDs comprising the light-emitting part emit light during the compensation period. The light-emitting part is configured to emit light by receiving the first drive voltage or the second drive voltage.

### CROSS-REFERENCE TO RELATED APPLICATION

This application claims priority from and the benefit of Korean Patent Application No. 10-2013-0088169, filed on Jul. 25, 2013, which is hereby incorporated by reference for all purposes as if fully set forth herein.

### BACKGROUND

1. Field

Exemplary embodiments of the present inventive concept relate to an LED luminaire. More particularly, exemplary embodiments relate to an LED luminaire capable of reducing light output deviation in operating sections by removing a non-light emitting section using a power factor compensation circuit, and/or by increasing a ratio of LEDs, which emit light in a section (compensation section) compensated by the power factor compensation circuit, to LEDs constituting the LED luminaire, and/or by constituting LEDs, which emit light only in at least some of non-compensation sections (normal operation section), to have lower luminous flux than the remaining LEDs, and/or by supplying lower LED drive current to LEDs, which emit only in at least some of the non-compensation sections, than the LED driving current supplied to LEDs in other sections.

2. Discussion of the Background

LEDs are generally operated by direct current (DC) driving. DC driving may require an AC-DC converter such as an SMPS and the like, and such a power converter may cause various problems such as increase in manufacturing costs of luminaries, difficulty in size reduction of the luminaires, deterioration in energy efficiency of the luminaires, and reduction in lifespan of the luminaires due short lifespan of such power converters.

To resolve such problems of DC driving, AC driving of LEDs has been suggested. However, an AC driving circuit may cause not only a problem of reduction in power factor due to mismatch between input voltage and output power in the LEDs, but also flickering perceived by a user in the case where a non-light emitting section of LEDs is extended.

FIG. 1 is a conceptual view illustrating a flicker index. A definition and regulation of the flicker index as a reference flicker level in accordance with Energy Star specifications will be described hereinafter.

As shown in FIG. 1, the term flicker index means a value obtained by dividing an area (Area1) above the level of average light output by the total light output area (Area1+Area2) on a light output waveform of one cycle. Thus, the flicker index is a value numerically indicating frequency of illumination above the level of average light output in one cycle, and a low flicker index indicates a better flicker level.

Flicker level may be assessed in accordance with Energy Star specifications. First, light output waveform is at least 120 Hz. Second, the flicker index is less than or equal to frequency multiplied by 0.001 (at maximum dimming, excluding flicker index at 800 Hz or more). Thus, the flicker index at 120 Hz is less than or equal to 0.12, for example, to meet the Energy Star standard.

### SUMMARY

Exemplary embodiments of the present disclosure provide an LED luminaire that can provide natural light through reduction in light output deviation by removing a non-light emitting section.

Exemplary embodiments of the present disclosure also provide an LED luminaire that can provide natural light through reduction in light output deviation, by increasing a ratio of LEDs, which emit light in a compensation section by a power factor compensation circuit, to LEDs constituting the LED luminaire.

Exemplary embodiments of the present disclosure also provide an LED luminaire that can provide natural light through reduction in light output deviation by constituting LEDs, which emit light only in at least some of non-compensation sections, to have lower luminous flux than the remaining LEDs.

Exemplary embodiments of the present disclosure also provide an LED luminaire that can provide natural light through reduction in light output deviation by supplying lower LED drive current to LEDs, which emit only in at least some of the non-compensation sections, than the LED driving current supplied to LEDs in other sections.

Additional features of the inventive concept will be set forth in the description which follows, and in part will be apparent from the description, or may be learned by practice of the exemplary embodiments.

An exemplary embodiment of the present disclosure provides an LED luminaire including: a rectification unit that is connected to an AC power source to perform full-wave rectification of AC voltage and supplies a first full-wave rectified voltage to an LED light emitting part as a first drive voltage; a power factor compensation unit that is charged with energy using the rectified voltage in a charge section and supplies a second drive voltage to the LED light emitting part in a compensation section; the LED light emitting part comprising a first LED group to an n^{th} LED group (n being a positive integer of 2 or more), emitting light by receiving the first drive voltage in the charge section and emitting light by receiving the second drive voltage in the compensation section; and an LED drive controller determining a voltage level of the first drive voltage or the second drive voltage and controlling sequential driving of the first LED group to the n^{th} LED group according to the determined voltage level, wherein the LED light emitting part allows at least 60% of LEDs constituting the LED light emitting part to emit light in the compensation section.

A ratio of total forward voltage level of at least one LED group emitting light in the compensation section to total forward voltage level of at least one LED group not emitting in the compensation section is 1:1.

N may be 4 and a ratio of forward voltage levels of the first to fourth LED groups is 1:1:1:3.

A ratio of the number of LEDs constituting the first, second, third and fourth LED groups is 5:5:5:6.

N may be 4 and a ratio of forward voltage levels of the first to fourth LED groups is 2:1:1:2.

A ratio of the number of LEDs constituting the first, second, third and fourth LED groups is 10:5:4:2.

LEDs constituting at least one LED group emitting light only in at least some of non-compensation sections has a first luminous flux and LEDs constituting LED groups except for the at least one LED group has a second luminous flux lower than the first luminous flux.

LEDs constituting the first to n−1^{th} LED groups has a first luminous flux and LEDs constituting the n^{th} LED group has a second luminous flux lower than the first luminous flux.

The LED drive controller controls LED drive current for driving the LED light emitting part emitting light only in at least some of non-compensation sections, in which at least one LED group emits light, to be lower than LED drive current for driving the LED light emitting part in other sections of the non-compensation sections.

The LED drive controller controls an n^{th} LED drive current to be lower than an n−1^{th} LED drive current.

The power factor compensation unit is a valley-fill circuit and may compensate for ½ of a total forward voltage level of the first to n^{th} LED groups.

According to an exemplary embodiment of the present disclosure, the LED luminaire can provide natural light to a user through reduction in light output deviation by removing a non-light emitting section.

According to an exemplary embodiment of the present disclosure, the LED luminaire can provide natural light through reduction in light output deviation by increasing a ratio of LEDs, which emit light in a compensation section by a power factor compensation circuit, to LEDs constituting the LED luminaire.

According to an exemplary embodiment of the present disclosure, the LED luminaire can provide natural light through reduction in light output deviation by constituting LEDs, which emit light only in at least some of non-compensation sections, to have lower luminous flux than the remaining LEDs.

According to exemplary embodiments, the LED luminaire can provide natural light through reduction in light output deviation by supplying lower LED drive current to LEDs, which emit only in at least some of the non-compensation sections, than the LED driving current supplied to LEDs in other sections.

It is to be understood that both the foregoing general description and the following detailed description are exemplary and explanatory and are intended to provide further explanation of the inventive concept as claimed.

### BRIEF DESCRIPTION OF THE DRAWINGS

The accompanying drawings, which are included to provide a further understanding of the inventive concept and are incorporated in and constitute a part of this specification, illustrate exemplary embodiments of the inventive concept, and together with the description serve to explain the principles of the inventive concept.

FIG. 1 is a conceptual view of flicker index.

FIG. 2 is a schematic block diagram of an LED luminaire according to an exemplary embodiment of the present disclosure.

FIG. 3A is a configuration view of an LED light emitting part according to an exemplary embodiment of the present disclosure.

FIG. 3B shows a light output waveform with reference to a positive half-cycle of AC voltage of the LED light emitting part shown in FIG. 3A.

FIG. 4A is a configuration view of an LED light emitting part according to an exemplary embodiment of the present disclosure.

FIG. 4B shows a light output waveform with reference to a positive half-cycle of AC voltage of the LED light emitting part shown in FIG. 4A.

FIG. 5A shows graphs comparing light output waveforms of the LED light emitting part according to the exemplary embodiment of FIG. 3A, depending upon the presence of LED mixing.

FIG. 5B shows graphs comparing light output waveforms of the LED light emitting part according to the exemplary embodiment of FIG. 4A, depending upon the presence of LED mixing.

FIG. 6 shows graphs comparing light output waveforms depending upon control of LED drive current by an LED drive controller according to the exemplary embodiment of FIG. 3A.

FIG. 7 shows a graph depicting relationship between flicker index and LED drive current of the LED drive controller according to the exemplary embodiment of the FIG. 3A.

### DETAILED DESCRIPTION OF THE ILLUSTRATED EMBODIMENTS

The present inventive concept will be described more fully hereinafter with reference to the accompanying drawings, in which exemplary embodiments of the inventive concept are illustrated. These exemplary embodiments will be described such that the inventive concept can be realized by a person having ordinary knowledge in the art. Although various exemplary embodiments are disclosed herein, it should be understood that these exemplary embodiments are not intended to be exclusive. For example, individual structures, elements or features of a particular exemplary embodiment are not limited to that particular exemplary embodiment and can be applied to other exemplary embodiments without departing from the spirit and scope of the inventive concept. In addition, it should be understood that locations or arrangement of individual components in each of the exemplary embodiments may be changed without departing from the spirit and scope of the present inventive concept. Therefore, the following exemplary embodiments are not to be construed as limiting the inventive concept, and the present inventive concept should be limited only by the claims and equivalents thereof. Like components having the same or similar functions will be denoted by like reference numerals.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, the term “LED group” means a set of plural LEDs (or plural light emitting cells), which are connected in, parallel, or series-parallel to each other such that operation of the LEDs (or light emitting cells) can be controlled as a single unit (that is, simultaneously turned on/turned off) by an LED drive module.

In addition, the term “unit forward voltage level Vf” refers to a forward voltage level of LEDs, LED chips, LED modules, and the like in an LED group. The unit forward voltage level Vf may be used as a unit for relatively representing forward voltage levels of LED groups, and must be understood as a relative concept rather than a fixed value. Accordingly, when a first LED group has a forward voltage level of 2 Vf and a second LED group has a forward voltage level of 1 Vf, the forward voltage level of the first LED group is two times higher than that of the second LED group.

Further, the term “first forward voltage level Vf1” means a critical voltage level capable of driving the first LED group, the term “second forward voltage level Vf2” means a critical voltage level capable of driving the first LED group and the second LED group connected to each other in series (that is, the sum of the forward voltage level of the first LED group and the forward voltage level of the second LED group), and the term “third forward voltage level Vf3” means a critical voltage level capable of driving the first to third LED groups connected to each other in series. That is, the term “n^{th} forward voltage level Vfn” means a critical voltage level capable of driving the first to n^{th} LED groups connected to each other in series (that is, the sum of the forward voltage levels of the first to n^{th} LED groups).

Further, the term “sequential driving” means sequentially turning on a plurality of LED groups by an LED drive module, which drives LEDs upon receiving an input voltage varying over time, to emit light as the input voltage applied to the LED drive module increases, while sequentially turning off the plurality of LED groups as the input voltage applied to the LED module decreases.

Further, the term “first drive voltage” means an input voltage itself or a drive voltage obtained from the input voltage processed through a certain device (for example, through a rectification circuit) and primarily supplied to the LED groups. Further, the term fined from the input voltage processed through a certain device (for example, varying over time, to emit light as the inpondarily supplied from the energy storage device to the LED groups. By way of example, such a second drive voltage may be a drive voltage obtained from the input voltage stored in a capacitor and then supplied from the charged capacitor to the LED groups. Accordingly, unless specifically referred to as the “first drive voltage” or the “second drive voltage”, the term “drive voltage” generally includes the first drive voltage and/or the second drive voltage supplied to the LED groups.

Further, the term “compensation section” means a period in which the level of input voltage (rectified voltage) is less than a preset forward voltage level in sequential driving and drive current is not supplied to an LED group. For example, a first forward voltage level Vf1 compensation section means a period in which the level of the rectified voltage is less than Vf1. In this case, the compensation section becomes a non-light emitting section. Further, a second forward voltage level Vf2 compensation section means a section in which the level of the rectified voltage is less than Vf2. Thus, an n^{th} forward voltage level Vfn compensation section means a period in which the level of the rectified voltage is less than Vfn. Further, first forward voltage level Vf1 compensation means operation of supplying the second drive voltage to the LED group to supply drive current to the LED group in the first forward voltage level Vf1 compensation section, and second forward voltage level Vf2 compensation means operation of supplying the second drive voltage to the LED group in the second forward voltage level Vf2 compensation section. Thus, n^{th} forward voltage level Vfn compensation means operation of supplying the second drive voltage to the LED group in the n^{th} forward voltage level Vfn compensation section.

Further, the term “non-compensation section” (or “normal operation section”) means a period in which the level of the input voltage (rectified voltage) is greater than or equal to a preset forward voltage level in sequential driving, such that the input voltage (first drive voltage) is supplied to LED group(s) to operate the LED group(s) to emit light. By way of example, in an embodiment in which first forward voltage level Vf1 compensation is carried out, the “non-compensation section” (or “normal operation section”) means a period in which the level of the input voltage is Vf1 or more, and in an embodiment in which second forward voltage level Vf2 compensation is carried out, the term “non-compensation section” (or “normal operation section”) means a period in which the level of the input voltage is Vf2 or more. Accordingly, in an embodiment in which the n^{th} forward voltage level Vfn compensation is carried out, the term “non-compensation section” (or “normal operation section”) means a period in which the level of the input voltage is greater than or equal to Vfn.

Further, as used herein, terms V1, V2, V3, . . . , t1, t2, . . . , T1, T2, T3, and the like used to indicate certain voltages, certain time points, certain temperatures, and the like are relative values for differentiation from one another rather than absolute values.

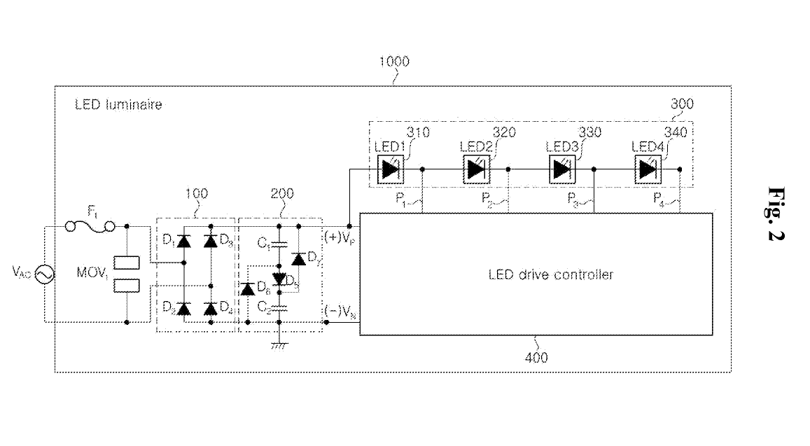

FIG. 2 is a schematic block diagram of an LED luminaire 1000 according to an exemplary embodiment of the present disclosure. Hereinafter, features and functions of an LED luminaire 1000 will be described with reference to FIG. 2.

Referring to FIG. 2, the LED luminaire 1000 may include a rectification unit 100, a power factor compensation unit 200, an LED light emitting part 300, and an LED drive controller 400.

First, the LED light emitting part 300 may be composed of a plurality of LED groups, which are sequentially turned on to emit light or sequentially turned off by control of the LED drive controller 400. In FIG. 2, the LED light emitting part 300 is illustrated as including a first LED group 310, a second LED group 320, a third LED group 330, and a fourth LED group 340.

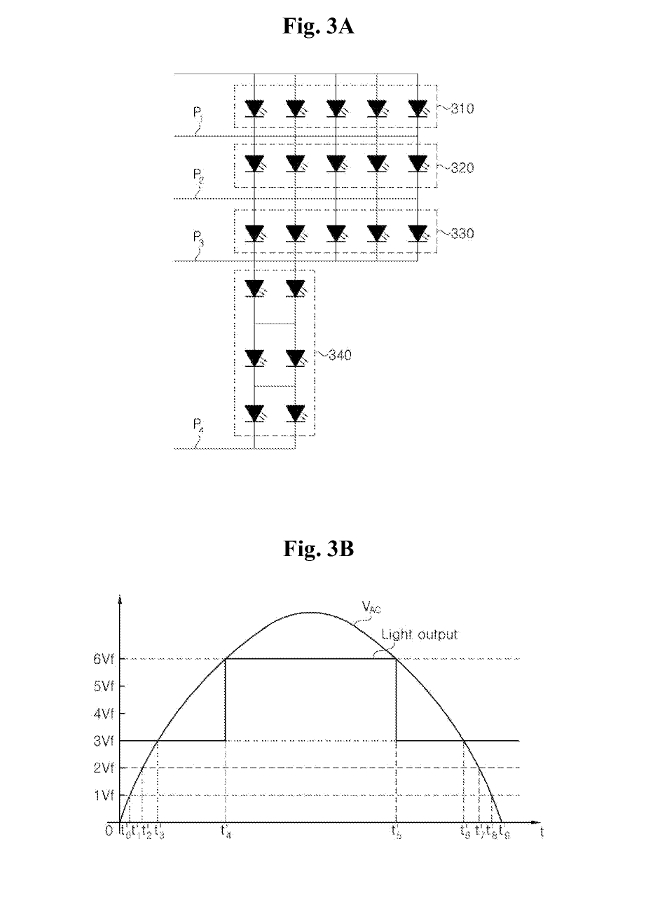

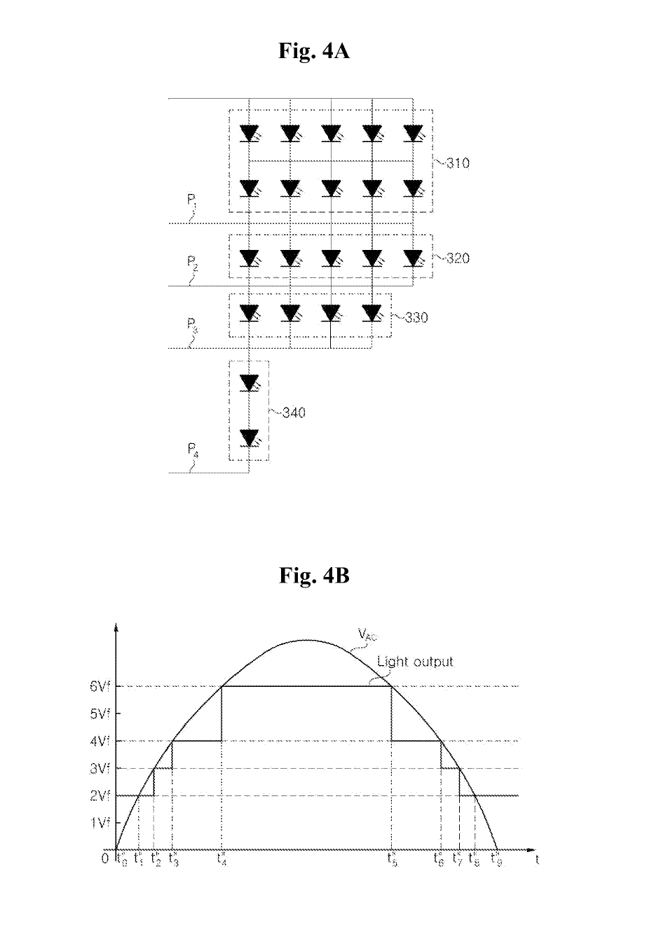

The first LED group 310, the second LED group 320, the third LED group 330, and the fourth LED group 340 may have different forward voltage levels. For example, when each of the first to fourth LED groups 310, 320, 330, 340 includes a different number of LEDs, the first to fourth LED groups 310, 320, 330, 340 will have different forward voltage levels from one another. This feature will be described in more detail with reference to FIGS. 3A and 4A below.

FIG. 3A is a configuration view of an LED light emitting part according to a first exemplary embodiment of the present disclosure. As shown in FIG. 3A, each of the first to third LED groups 310 to 330 is composed of five LED strings each including a single LED, and connected in parallel to each other. Thus, each of the first to third LED groups 310 to 330 has a forward voltage level of 1 Vf. However, since the fourth LED group 340 is composed of two LED strings connected in parallel to each other, each LED string including three LEDs connected in series, the fourth LED group 340 has a forward voltage level of 3 Vf. Thus, in the LED light emitting part 300 as shown in FIG. 3A, the ratio of forward voltage levels of the first LED group 310 to the fourth LED group 340 becomes 1:1:1:3.

FIG. 4A is a configuration view of an LED light emitting part according to a second exemplary embodiment of the present disclosure. As shown in FIG. 4A, since the first LED group 310 is composed of five LED strings connected in parallel to each other and each including two LEDs connected in series, the first LED group 310 has a forward voltage level of 2 Vf. In addition, since the second LED group 320 is composed of five LED strings connected in parallel to each other and each including a single LED, the second LED group 320 has a forward voltage level of 1 Vf, and since the third LED group 330 is composed of four LED strings connected in parallel to each other and each including a single LED, the third LED group 330 has a forward voltage level of 1 Vf. In addition, since the fourth LED group 340 is composed of an LED string including two LEDs, the fourth LED group 340 has a forward voltage level of 2 Vf. Thus, in the LED light emitting part 300 as shown in FIG. 4A, the ratio of forward voltage levels of the first LED group 310 to the fourth LED group 340 becomes 2:1:1:2.

Improvement of flicker index resulting from constitutional difference between the LED light emitting parts 300 according to the first and second exemplary embodiments will be described below with reference to FIGS. 3B and 4B.

Referring to FIG. 2 again, the rectification unit 100 according to the present exemplary embodiment is configured to generate and output a rectified voltage Vrec by rectifying AC voltage V_{AC} input from an external power source. As for the rectification unit 100, any rectification circuit, such as a full-wave rectification circuit or a half-wave rectification circuit, may be used. The rectification unit 100 is configured to supply the rectified voltage Vrec to the power factor compensation unit 200, the LED light emitting part 300, and the LED drive controller 400. FIG. 2 shows a bridge full-wave rectification circuit composed of four diodes D1, D2, D3, and D4.

The power factor compensation unit 200 according to the present exemplary embodiment is configured to be charged with energy using the rectified voltage Vrec in a charge section (which may be referred to as a charge period) and to supply a second drive voltage to the LED light emitting part 300 in a compensation section (which may be referred to as a compensation period). In FIG. 2, a valley-fill circuit composed of a first capacitor C1, a second capacitor C2 and three anti-reverse flow diodes D5, D6, and D7 is shown as the power factor compensation unit 200 according to the present inventive concept. Herein, since the configuration and functions of the valley-fill circuit are known in the art, detailed descriptions thereof will be omitted.

The forward voltage level compensated by the power factor compensation unit 200 according to the present exemplary embodiment may be designed in various ways according to capacitance of charge/discharge devices (for example, the first capacitor C1, second capacitor C2, and the like of FIG. 2) constituting the power factor compensation unit 200. The power factor compensation unit 200 according to the present exemplary embodiment may be configured to compensate for a voltage level corresponding to ½ of the total forward voltage level (the sum of forward voltage levels of the LED groups). The LED light emitting part 300 shown in FIGS. 3A and 4A has a total forward voltage level of 6 Vf and, in this case, the power factor compensation unit 200 according to the present exemplary embodiment may be configured to compensate for a voltage level of 3 Vf. For convenience of description and understanding, the power factor compensation unit 200 will be described with reference to exemplary embodiments configured to compensate for a voltage level of ½ of the total forward voltage level (in the exemplary embodiments of FIGS. 3A and 4A, a voltage level of 3 Vf).

The LED drive controller 400 according to the present exemplary embodiment detects a voltage level of an input drive voltage (the first drive voltage (rectified voltage Vrec) supplied from the rectification unit 100 in a non-compensation section or the second drive voltage supplied from the power factor compensation unit 200 in a compensation section), and determines the magnitude of LED drive current to be supplied to the light emitting part 300 (more specifically, to each of the plurality of LED groups 310 to 340 included in the light emitting part 300) and time points of supplying and shutting off the LED drive current according to the magnitude of the detected drive voltage. In addition, the LED drive controller 400 is configured to control sequential driving of the LED light emitting part 300 by supplying the LED drive current having the determined magnitude to one or plural LED groups (one or more of the LED groups 310 to 340) at a determined time point, and stopping supply of the LED drive current to the one or plural LED groups (one or more of the LED groups 310 to 340) at a determined shut-off time point.

More specifically, the LED drive controller 400 according to the present exemplary embodiment is configured to control sequential driving of the first LED group 310 to the fourth LED group 340 by controlling connection and disconnection of a first current path P1, a second current path P2, a third current path P3, and a fourth current path P4 according to the level of the drive voltage Vp. In addition, the LED drive controller 400 is configured to perform constant current control. To this end, the LED drive controller 400 may include a constant current controller (not shown). The constant current controller may be implemented by various technologies known in the art. For example, the constant current controller may include a sensing resistor for detecting current, a differential amplifier for comparing a currently detected current value with a reference current value, and a switching device configured to control connection of a current path according to output from the differential amplifier and to control the LED drive current flowing through the current path to become constant current when the path is connected thereto.

In a section in which the level of the drive voltage Vp is greater than or equal to the first forward voltage level Vf1 and is less than the second forward voltage level Vf2, the first current path P1 is connected to the LED drive controller 400 under control of the LED drive controller 400, whereby a first LED drive current I_{LED1} flows through the first current path P1. The LED drive controller 400 detects the first LED drive current I_{LED1} and performs constant current control such that the first LED drive current I_{LED1} can be maintained at a first reference current I_{REF1}.

Similarly, in a section in which the level of the drive voltage Vp is greater than or equal to the second forward voltage level Vf2 and is less than a third forward voltage level Vf3, the second current path P2 is connected to the LED drive controller 400 under control of the LED drive controller 400, whereby a second LED drive current I_{LED2} flows through the second current path P2. The LED drive controller 400 detects the second LED drive current I_{LED2} and performs constant current control such that the second LED drive current I_{LED2} can be maintained at a second reference current I_{REF2}.

In addition, in a section in which the level of the drive voltage Vp is greater than or equal to the third forward voltage level Vf3 and is less than a fourth forward voltage level Vf4, the third current path P3 is connected to the LED drive controller 400 under control of the LED drive controller 400, whereby a third LED drive current I_{LED3} flows through the third current path P3. The LED drive controller 400 detects the third LED drive current I_{LED3} and performs constant current control such that the third LED drive current I_{LED3} can be maintained at a third reference current I_{REF3}.

Last, in a section in which the level of the drive voltage Vp is greater than or equal to the fourth forward voltage level Vf4, the fourth current path P4 is connected to the LED drive controller 400 under control of the LED drive controller 400, whereby a fourth LED drive current I_{LED4} flows through the fourth current path P4. The LED drive controller 400 detects the fourth LED drive current I_{LED4} and performs constant current control such that the fourth LED drive current I_{LED4} can be maintained at a fourth reference current I_{REF4}.

In order to improve power factor (PF) and total harmonic distortion (THD) characteristics, the LED drive controller 400 according to the present exemplary embodiment sets the first reference current I_{REF1}, the second reference current I_{REF2}, the third reference current I_{REF3}, and the fourth reference current I_{REF4} to be different from one another such that a waveform of the LED drive current approaches the waveform of the rectified voltage, whereby the first LED drive current I_{LED1} to the fourth LED drive current I_{LED4} approach a sine waveform. For example, the LED drive controller 400 may perform constant current control to set the fourth LED drive current I_{LED4} to 85 mA, to set the third LED drive current I_{LED3} to a value in the range of 80%˜95% of the fourth LED drive current I_{LED4}, to set the second LED drive current I_{LED2} to a value in the range of 65%˜80% of the fourth LED drive current I_{LED4}, and to set the first LED drive current I_{LED1} to a value in the range of 30%˜65% of the fourth LED drive current I_{LED4}.

Improvement of Flicker Index of LED Luminaire 1000

Next, improving the flicker index of the LED luminaire 1000 according to exemplary embodiments of the present inventive concept configured as described above will be described. Generally, exemplary embodiments provide three methods for improving flicker index.

First, the flicker index can be improved by increasing the ratio of LEDs, which are set to emit light in a compensation section (as explained above, section is also referred to as period), in the LED light emitting part 300 of the LED luminaire 1000. For example, in an exemplary embodiment of present invention, the LED light emitting part 300 of the LED luminaire 1000 may be configured such that the number of the LEDs emitting light during the compensation section is greater than the number of the LEDs emitting light only during the non-compensation section. Second, the flicker index can be improved by designing LEDs, which are set to emit light only in at least some of non-compensation sections, to have lower luminous flux than the remaining LEDs, in the LED light emitting part 300 of the LED luminaire 1000. Third, the flicker index can be improved by allowing the LED drive controller 400 to control the LED drive current supplied to the LEDs, which are set to emit light only in at least some of the non-compensation sections, to be lower than the LED drive current supplied to LEDs in other sections. Hereinafter, each of the methods for improving the flicker index will be described in more detail with reference to FIG. 3A to FIG. 6.

Improvement of flicker index through change of configuration of LED light emitting part 300

First, referring to FIGS. 3A to 4B, the method of improving the flicker index of the LED luminaire 1000 by changing the configuration of the LED light emitting part 300 will be described. According to the present exemplary embodiment, each of LED light emitting parts 300 shown in FIG. 3A and FIG. 4A includes 21 LEDs. In addition, the LED light emitting part 300 according to the present exemplary embodiment has a total forward voltage level of 6 Vf and the power factor compensation unit 200 is configured to compensate for a voltage level of 3 Vf.

FIG. 3A is a configuration view of an LED light emitting part according to a first exemplary embodiment and FIG. 3B is a light output waveform with reference to a positive half-cycle of AC voltage of the LED light emitting part shown in FIG. 3A. As described above with reference to FIG. 3A, the first LED group 310 includes five LEDs and the forward voltage level of the first LED group 310 is 1 Vf. In addition, the second LED group 320 includes five LEDs and has a forward voltage level of 1 Vf. The third LED group 330 includes five LEDs and has a forward voltage level of 1 Vf, and the fourth LED group 340 includes six LEDs and has a forward voltage level of 3 Vf. Since a maximum voltage level capable of being compensated by the power factor compensation unit 200 is 3 Vf, the first LED group 310, the second LED group 320, and the third LED group 330 emit light in the compensation section.

As a result, the number of LEDs emitting light in the compensation section is 15 (about 71% of the total number of LEDs). Consequently, the LED light emitting part 300 according to the first exemplary embodiment as shown in FIG. 3A exhibits a light output waveform as shown in FIG. 3B. As shown in FIG. 3B, the first LED group 310, the second LED group 320, and the third LED group 330 are compensated by the power factor compensation unit 200 and thus kept in a light emitting state, and the fourth LED group 340 emits light in a section in which the level of the drive voltage Vp is 6 Vf or more. Accordingly, as measured under the same conditions as those shown in FIG. 3A and FIG. 3B, the LED luminaire 1000 including the LED light emitting part 300 according to the first exemplary embodiment has a flicker index of 0.163.

FIG. 4A is a configuration view of an LED light emitting part according to a second exemplary embodiment and FIG. 4B shows a light output waveform with reference to a positive half-cycle of AC voltage of the LED light emitting part shown in FIG. 4A. As described with reference to FIG. 4A, the first LED group 310 includes ten LEDs and has a forward voltage level of 2 Vf. In addition, the second LED group 320 includes five LEDs and has a forward voltage level of 1 Vf. The third LED group 330 includes four LEDs and has a forward voltage level of 1 Vf, and the fourth LED group 340 includes two LEDs and has a forward voltage level of 2 Vf. Since a maximum voltage level capable of being compensated by the power factor compensation unit 200 is 3 Vf, the first LED group 310 and the second LED group 320 emit light in the compensation section. As a result, the number of LEDs emitting light in the compensation section is 15 (about 71% of the total number of LEDs).

Consequently, the LED light emitting part 300 according to the second exemplary embodiment as shown in FIG. 4A exhibits a light output waveform as shown in FIG. 4B. As shown in FIG. 4B, the first LED group 310 and the second LED group 320 are compensated by the power factor compensation unit 200 and thus kept in a light emitting state, the third LED group 330 emits light in a section in which the level of the drive voltage Vp is 4 Vf or more, and the fourth LED group 340 emits light in a section in which the level of the drive voltage Vp is 6 Vf or more. In this case, as measured under the same conditions as those shown in FIG. 3A and FIG. 3B, the LED luminaire 1000 including the LED light emitting part 300 according to the second exemplary embodiment has a flicker index of 0.161.

Table 1 shows flicker indices of the LED luminaires 1000 including the LED light emitting parts 300 according to the first and second exemplary embodiments.

TABLE 1

| | | Ratio of LEDs | |
|---|---|---|---|
| | | emitting | |
| | | light in | |
| | Configuration of light emitting | compensation | |
| | part | section | F/I |
| First | 1 (five)-1(five)-1 (five)-3 (six) | 71% | 0.163 |
| embodiment | | | |
| Second | 2 (ten)-1 (five)-1 (four)-2 (two) | 71% | 0.161 |
| embodiment | | | |

In Table 1, the flicker index of the LED luminaire is improved with increasing ratio of the number of LEDs emitting light in the compensation section to the total number of LEDs. In addition, even when the LED light emitting part 300 is configured such that the same number of LEDs emit light in the compensation section, the flicker index of the LED luminaire is improved with increasing number of the LEDs included in the LED group emitting light in a low voltage level. That is, although both LED light emitting parts according to the first and second exemplary embodiments are configured such that fifteen LEDs emit light in the compensation section, the LED luminaire including the light emitting part according to the second exemplary embodiment, in which the first LED group 310 includes ten LEDs and the second LED group 320 includes five LEDs, has a better flicker index than the LED luminaire including the light emitting part according to the first exemplary embodiment, in which the first LED group 310 includes five LEDs, the second LED group 320 includes five LEDs, and the third LED group 330 includes five LEDs.

Improvement of Flicker Index by LED Mixing

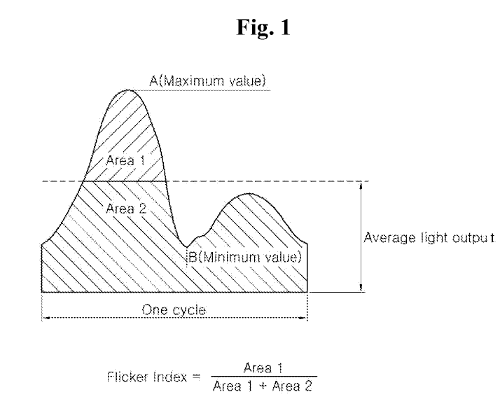

In addition to the method of improving the flicker index by changing the configuration of the LED light emitting part 300, an additional method of improving the flicker index is proposed. The LED light emitting part 300 of the LED luminaire 1000 may comprise all the same kind of LEDs. However, the flicker index may be improved by combining different kinds of LEDs according to LED groups. That is, as illustrated with reference to FIG. 1, in one cycle, more uniform light output provides a better flicker index and higher deviation of light output provides a lower flicker index. Luminous flux of LEDs can be considered as one factor capable of influencing light output, and the LED light emitting part 300 according to the present exemplary embodiment can be configured based on the luminous flux.

That is, in the LED light emitting part 300 according to the present exemplary embodiment, at least one LED group emitting light only in a section of higher light output than average light output comprises LEDs having lower luminous flux than LEDs comprising other LED groups, thereby reducing deviation of light output. In the LED light emitting part 300 according to the present exemplary embodiment, an LED group emitting light in the compensation section may comprise LEDs having a relatively high luminous flux and an LED group not emitting in the compensation section may comprise LEDs having a relatively low luminous flux. In some exemplary embodiments, there can be plural LED groups not emitting light in the compensation section, and all of these LED groups may comprise LEDs having low luminous flux, or only some of these LED groups may comprise LEDs having low luminous flux.

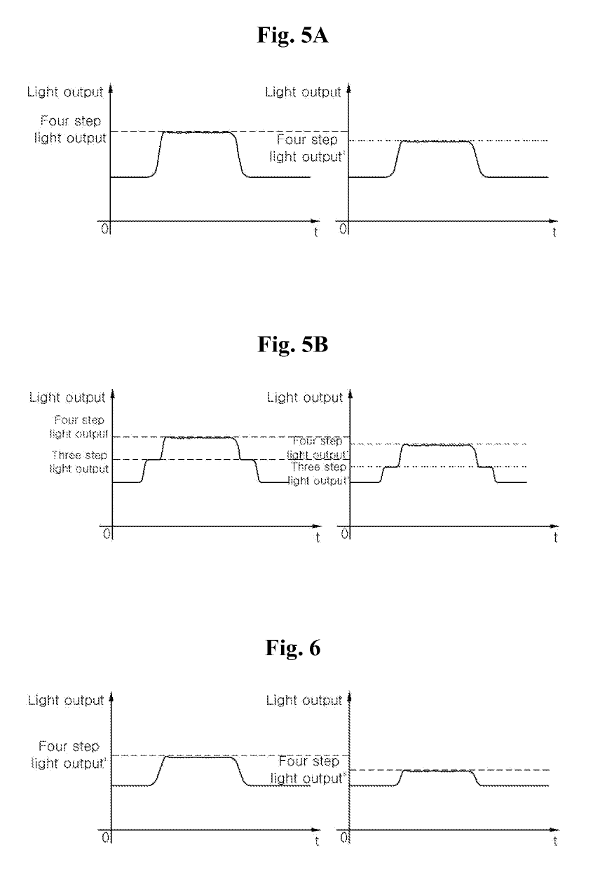

FIG. 5A shows graphs comparing light output waveforms of the LED light emitting part according to the first exemplary embodiment depending upon the presence of LED mixing. In FIG. 5A, the left side shows a light output waveform of the LED luminaire 1000 including the LED light emitting part 300 to which LED mixing is not applied, and the right side shows a light output waveform of the LED luminaire 1000 including the LED light emitting part 300 to which LED mixing is applied. In the LED luminaire 1000 including the LED light emitting part 300 to which LED mixing is applied, the first LED group 310 to the third LED group 330 emitting light in the compensation section may comprise LEDs having a first luminous flux, and the fourth LED group 340 not emitting light in the compensation section may comprise LEDs having a second luminous flux that is lower than the first luminous flux. FIG. 5A shows that the light output waveform of the LED luminaire 1000 to which LED mixing is applied has improved flicker index as compared with the flicker index of the light output waveform of the LED luminaire 1000 to which LED mixing is not applied.

FIG. 5B shows graphs comparing light output waveforms of the LED light emitting part according to the second exemplary embodiment, depending upon the presence of LED mixing. In FIG. 5B, the left side shows a light output waveform of the LED luminaire 1000 including the LED light emitting part 300 to which LED mixing is not applied, and the right side shows a light output waveform of the LED luminaire 1000 including the LED light emitting part 300 to which LED mixing is applied. In the LED luminaire 1000 including the LED light emitting part 300 to which LED mixing is applied, the first LED group 310 and the second LED group 320 emitting light in the compensation section may comprise LEDs having a relatively high luminous flux, and the third LED group 330 and the fourth LED group 340 not emitting light in the compensation section may comprise LEDs having a relatively low luminous flux. Further, in some exemplary embodiments, the first LED group 310 to the third LED group 330 may comprise LEDs having a relatively high luminous flux and the fourth LED group 340 may comprise LEDs having a relatively low luminous flux. As can be confirmed in FIG. 5B, the light output waveform of the LED luminaire 1000 to which LED mixing is applied has improved flicker index as compared with the flicker index of the light output waveform of the LED luminaire 1000 to which LED mixing is not applied.

Table 2 shows the flicker indices of the LED luminaires 1000 including the LED light emitting part 300 according to the first exemplary embodiment to which LED mixing is not applied, the LED light emitting part 300 according to the first exemplary embodiment to which LED mixing is applied, the LED light emitting part 300 according to the second exemplary embodiment to which LED mixing is not applied, and the LED light emitting part 300 according to the second exemplary embodiment to which LED mixing is applied, respectively.

TABLE 2

| | LED mixing | F/I |
|---|---|---|
| First embodiment | Not applied | 0.163 |
| (1-1-1-3 structure) | Applied | 0.142 |
| Second embodiment | Not applied | 0.161 |
| (2-1-1-2 structure) | Applied | 0.149 |

In Table 2, when the LED light emitting part 300 includes LED mixing, the flicker index of the LED luminaire is improved as compared with that of the LED luminaire when the LED light emitting part 300 without LED mixing.

Improvement of Flicker Index Through Control of LED Drive Current

In addition to the method of improving the flicker index by changing the configuration of the LED light emitting part 300 or by LED mixing, an additional method of improving the flicker index is proposed. LED drive current I_{LED} can be considered as one factor capable of influencing light output, and the LED light emitting part 400 according to the present exemplary embodiment can be configured based on the LED drive current. That is, the flicker index can be improved under control of the LED drive controller 400 such that the LED drive current I_{LED} supplied to the LED light emitting part 300 in a section of higher light output than average light output is lower than the LED drive current I_{LED} supplied to the LED light emitting part 300 in other sections.

In the LED luminaire 1000 including the LED light emitting part 300 according to the first exemplary embodiment, the first LED group 310 to the third LED group 330 emit light in the compensation section and all of the first LED group 310 to the fourth LED group 340 emit light in the non-compensation section, as described above. Thus, the LED drive current supplied to the first LED group 310 to the third LED group 330 in the compensation section is the third LED drive current I_{LED3}, and the LED drive current supplied to the first LED group 310 to the fourth LED group 340 in the non-compensation section is the fourth LED drive current I_{LED4}. Thus, the LED drive controller 400 according to the present exemplary embodiment can improve the flicker index by performing constant current control such that the fourth LED drive current I_{LED4} becomes lower than the third LED drive current I_{LED3}.

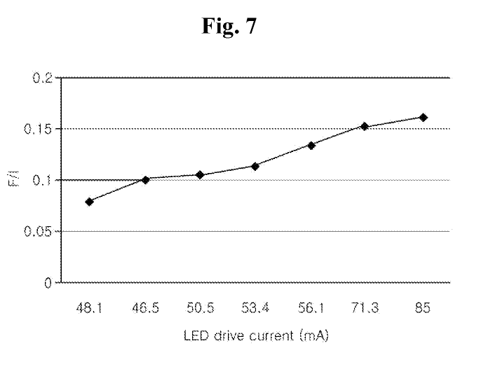

FIG. 6 shows graphs comparing light output waveforms depending upon control of LED drive current by the LED drive controller 400 according to the first exemplary embodiment. In FIG. 6, the left side shows a light output waveform of a general configuration in which the LED drive controller 400 controls the fourth LED drive current I_{LED4} to be higher than the third LED drive current I_{LED3}, and the right side shows a light output waveform in the case where the LED drive controller 400 controls the fourth LED drive current I_{LED4} to be lower than the third LED drive current I_{LED3}. FIG. 6 shows that, in the case where the LED drive controller 400 controls the fourth LED drive current I_{LED4} to be lower than the third LED drive current I_{LED3}, the flicker index is improved as compared with other cases.

In the LED luminaire 1000 including the LED light emitting part 300 according to the second exemplary embodiment, in the compensation section, the first LED group 310 and the second LED group 320 emit light, as described above, and at this time, the LED drive current is the second LED drive current I_{LED2}. In the non-compensation section, the first LED group 310 to the third LED group 330 emit light in a section in which the drive voltage Vp has a voltage level of 4 Vf or higher and less than 6 Vf and the LED drive current is the third LED drive current I_{LED3}. Further, in the non-compensation section, the first LED group 310 to the fourth LED group 340 emit light in a section in which the drive voltage Vp has a voltage level of 6 Vf or more and the LED drive current is the fourth LED drive current I_{LED4}. Thus, in the present exemplary embodiment, the LED drive controller 400 may control both the third LED drive current I_{LED3} and the fourth LED drive current I_{LED4} to be lower than the second LED drive current I_{LED2}. Further, in another exemplary embodiment, the LED drive controller 400 may control the third LED drive current I_{LED3} to be higher than the second LED drive current I_{LED2} as in the general configuration, and may control only the fourth LED drive current I_{LED4} to be lower than the second LED drive current I_{LED2} and/or the third LED drive current I_{LED3}.

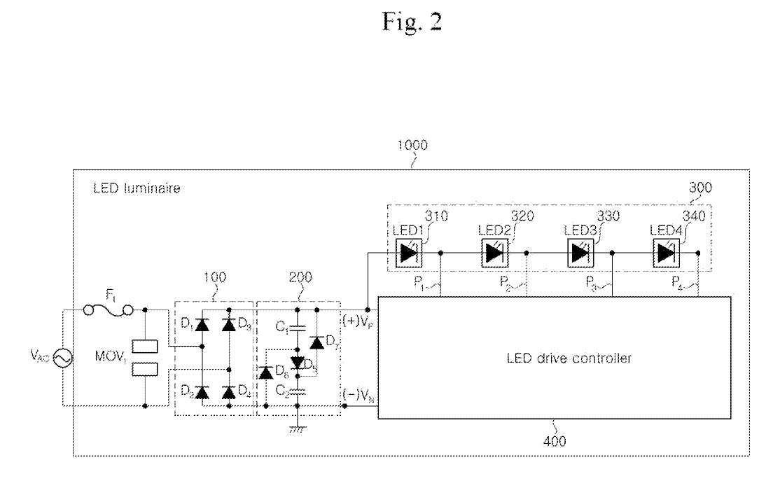

Table 3 and FIG. 7 show a graph depicting relationship between the flicker index and the LED drive current of the LED drive controller according to the first exemplary embodiment. FIG. 7 is a graph depicting variation of the flicker index depending upon the magnitude of the fourth LED drive current I_{LED4} in the LED luminaire 1000 including the LED light emitting part 300 according to the first exemplary embodiment.

TABLE 3

| Maximum drive current | Fourth LED drive current | | |
|---|---|---|---|
| (mA) | (mA) | Rate (%) | F/I |
| 85 | 41.8 | 49.18% | 0.083 |
| 85 | 46.5 | 54.71% | 0.100 |
| 85 | 50.5 | 59.41% | 0.105 |
| 85 | 53.4 | 62.82% | 0.113 |
| 85 | 56.1 | 66% | 0.131 |
| 85 | 71.3 | 83.88% | 0.152 |
| 85 | 85.0 | 100% | 0.161 |

In Table 3 and FIG. 7, the flicker index is further improved with decreasing magnitude of the fourth LED drive current I_{LED4}. As described above, unlike general sequential driving (that is, the configuration wherein the fourth LED drive current I_{LED4} is higher than any other LED drive current), since the overall light output of the LED luminaire 1000 can be lowered when the fourth LED drive current I_{LED4} is controlled to be low. Control of the fourth LED drive current I_{LED4} may be implemented by a constant current control function of the LED drive controller 400, or by a separate current limiting device.

In the above description, the three methods for improving the flicker index of the LED luminaire 1000 have been described. The aforementioned three methods may be independently applied to the LED luminaire 1000 or a combination of these method may be applied to the LED luminaire 1000.

Although some exemplary embodiments have been described above, it should be understood that the present inventive concept is not limited to the exemplary embodiments and features described above, and that various modifications, variations, and alterations can be made without departing from the spirit and scope of the inventive concept. Therefore, the scope of the inventive concept should be limited only by the accompanying claims and equivalents thereof.

What is claimed is:

1. A light-emitting diode (LED) luminaire, comprising:
a light-emitting part comprising a first LED group to an nth LED group (n being a positive integer of at least 2);
a rectification unit configured to perform full-wave rectification of an alternating current (AC) voltage to supply a first drive voltage to the light-emitting part;
a power factor compensation unit configured to be charged with the first drive voltage during a charge period and supply a second drive voltage to the light-emitting part during a compensation period; and
an LED drive controller configured to determine a voltage level of the first drive voltage or the second drive voltage and control sequential driving of the first LED group to the n^{th} LED group according to the determined voltage level,
wherein the light-emitting part is configured such that the number of the LEDs emitting light during the compensation period is greater than the number of the LEDs emitting light only during the charge period, and
wherein the light-emitting part is configured to emit light by receiving the first drive voltage or the second drive voltage.

2. The LED luminaire according to claim 1, wherein, the light-emitting part is configured such that at least 60% of the LEDs comprising the light-emitting part emit light during the compensation period.

3. The LED luminaire according to claim 1, wherein a ratio of a total forward voltage level of a first LED group in the compensation period to a total forward voltage level of a second LED group in the compensation period is 1:1.

4. The LED luminaire according to claim 3, wherein n is 4 and a ratio of forward voltage levels of first to fourth LED groups is 1:1:1:3.

5. The LED luminaire according to claim 4, wherein a ratio of the number of LEDs comprising the first, second, third, and fourth LED groups is 5:5:5:6.

6. The LED luminaire according to claim 3, wherein n is 4 and a ratio of forward voltage levels of the first to fourth LED groups is 2:1:1:2.

7. The LED luminaire according to claim 6, wherein a ratio of the number of LEDs comprising the first, second, third, and fourth LED groups is 10:5:4:2.

8. The LED luminaire according to claim 1, wherein:
LEDs comprising the first LED group have a first luminous flux; and
LEDs comprising LED groups other than the first LED group have a second luminous flux lower than the first luminous flux.

9. The LED luminaire according to claim 1, wherein:
LEDs constituting the first to n−1^{th} LED groups have a first luminous flux; and
LEDs constituting the n^{th} LED group have a second luminous flux lower than the first luminous flux.

10. The LED luminaire according to claim 1, wherein the LED drive controller is configured to control a drive current for driving the light-emitting part during a first portion of the charge period, to be lower than the drive current for driving the light-emitting part during a second portion of the charge period.

11. The LED luminaire according to claim 1, wherein the LED drive controller is configured to control an n^{th} LED group drive current to be lower than an n−1^{th} LED group drive current.

12. The LED luminaire according to claim 1, wherein the power factor compensation unit comprises a valley-fill circuit and is configured to compensate for ½ of a total forward voltage level of the first to n^{th} LED groups.
